(19) United States
(12) Patent Application Publication
(10) Pub. No.: US 2011/0061499 A1
(43) Pub. Date: Mar. 17, 2011

(54) Magnetic Double-Sided Ratchet Wrench With Built-In Removable Inserts

(76) Inventor: Damon L. Franklin, Queens Village, NY (US)

(21) Appl. No.: 12/870,744

(22) Filed: Aug. 27, 2010

Related U.S. Application Data
(60) Provisional application No. 61/275,331, filed on Aug. 28, 2009.

(51) Int. Cl. B25B 13/46; B25B 23/16

(52) U.S. Cl. 81/60; 81/177.4

(57) ABSTRACT

The present invention is a ratchet wrench that incorporates removable sockets into the wrench body. The removable inserts are integrated and stored in the wrench body. An insert of the desired size can be removed from the handle of the wrench body and placed within the opening of the wrench. The opening is configured to securely hold the insert and the opening includes a ratcheting mechanism so that the wrench can be used in a ratcheting manner. The ratcheting wrench has several uses including the fastening and/or removal of nuts, bolts, screws and other hardware.

### CROSS-REFERENCE TO RELATED APPLICATIONS

This application is a non-provisional utility patent application, and claims the benefit of U.S. Provisional Patent Application Ser. No. 61/275,331, filed on Aug. 28, 2009 which is expressly incorporated herein in its entirety by reference thereto.

### BACKGROUND OF THE INVENTION

The present invention relates to wrenches and more particularly, to ratchet wrenches. The present invention also relates to socket wrenches and ratcheting-type socket wrenches. In particular, the present invention relates to an improved type of ratcheting wrench with integrated socket type inserts that are stored in the body of the wrench.

### BRIEF SUMMARY OF THE INVENTION

The present invention relates to wrenches, specifically ratchet wrenches that use interchangeable sockets (Spry Sockets) for different sized nuts, bolts and other hardware. The present invention is a modernized ratchet wrench that incorporates removable sockets into the wrench body, providing the user with nine, as many as sixteen, or more different sized inserts/fittings, both imperial and metric sizes, without having to carry separate sized wrenches or socket cases.

The removable inserts are integrated and stored in the wrench body. An insert of the desired size can be removed from the handle of the wrench body and placed within the opening of the wrench. The opening is configured to securely hold the insert and the opening includes a ratcheting mechanism so that the wrench can be used in a ratcheting manner. The ratcheting wrench has several uses including the fastening and/or removal of nuts, bolts, screws and other hardware.

### BRIEF DESCRIPTION OF THE DRAWINGS

FIG. 1 is a frontal view of the magnetic double-sided ratchet wrench with built-in removable inserts.

FIG. 2 shows the different components of the magnetic double-sided ratchet wrench with built-in removable inserts.

FIG. 3 is a perspective view of the magnetic double-sided ratchet wrench with built-in removable inserts.

FIG. 4 illustrates a removable insert secured in place by the adjustable ring.

FIG. 5 shows a frontal view of the opposing magnetic cylinder embedded into the pawl.

FIG. 6 is a perspective view of another embodiment of the invention comprising a magnetic double-sided ratchet wrench with built-in removable inserts. Both ends of the wrench with the openings comprise a hinged/pivoting mechanism to provide angled use of the wrench.

FIG. 7 is a perspective view from the underside of the embodiment of the invention shown in FIG. 6.

FIG. 8 is a perspective view of another embodiment of the invention comprising a magnetic double-sided ratchet wrench with built-in removable inserts. One end of the ratchet includes the opening for the inserts and the other end includes a socket type screw head fitting for adaption of the wrench to a ratcheting screw driver.

FIG. 9 is a perspective view from the underside of the embodiment of the invention shown in FIG. 8.

FIG. 10 is a side view of the embodiment of the invention shown in FIG. 8.

FIGS. 11-13 are perspective views of another embodiment of the invention comprising a magnetic double-sided ratchet wrench with built-in removable inserts shown in the handle grip/body. The embodiment shown also comprises a collapsible drive adapter (shown in a stored position in the body). The collapsible drive adapter can also be secured in the opening of the wrench thereby making the wrench compatible with conventional sockets.

FIGS. 14-16 are perspective and exploded views of another embodiment of the invention comprising a magnetic double-sided ratchet wrench with built-in removable inserts shown in the handle grip/body. The embodiment shown also comprises a telescoping/extendable shaft to allow for extension of the wrench opening away from the grip/handle using a threaded compression connector and a secured connection. The inserts in FIGS. 15 and 16 are configured on the outside diameter to include teeth/notches/grooves for engaging one or more pawls located in the opening of the wrench.

FIGS. 17 and 18 show multiple views of the collapsible drive adapter, including exploded views, open and closed views, and front, top, bottom and side views.

### DETAILED DESCRIPTION OF THE INVENTION

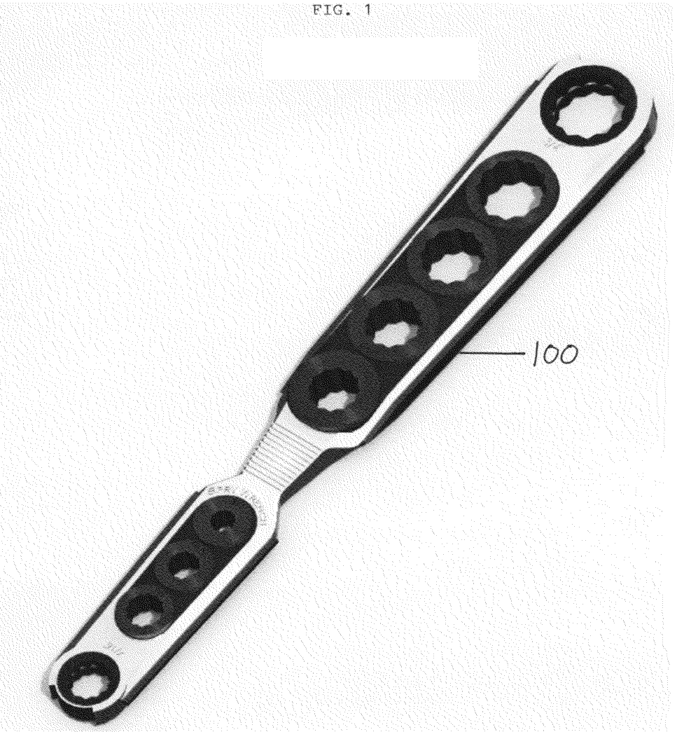

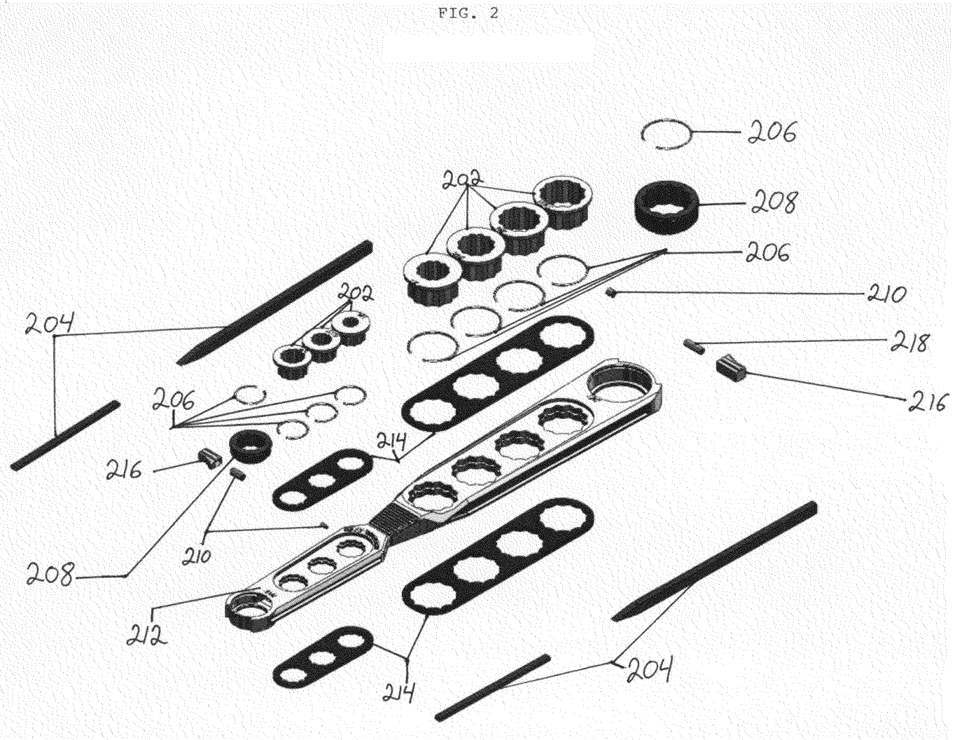

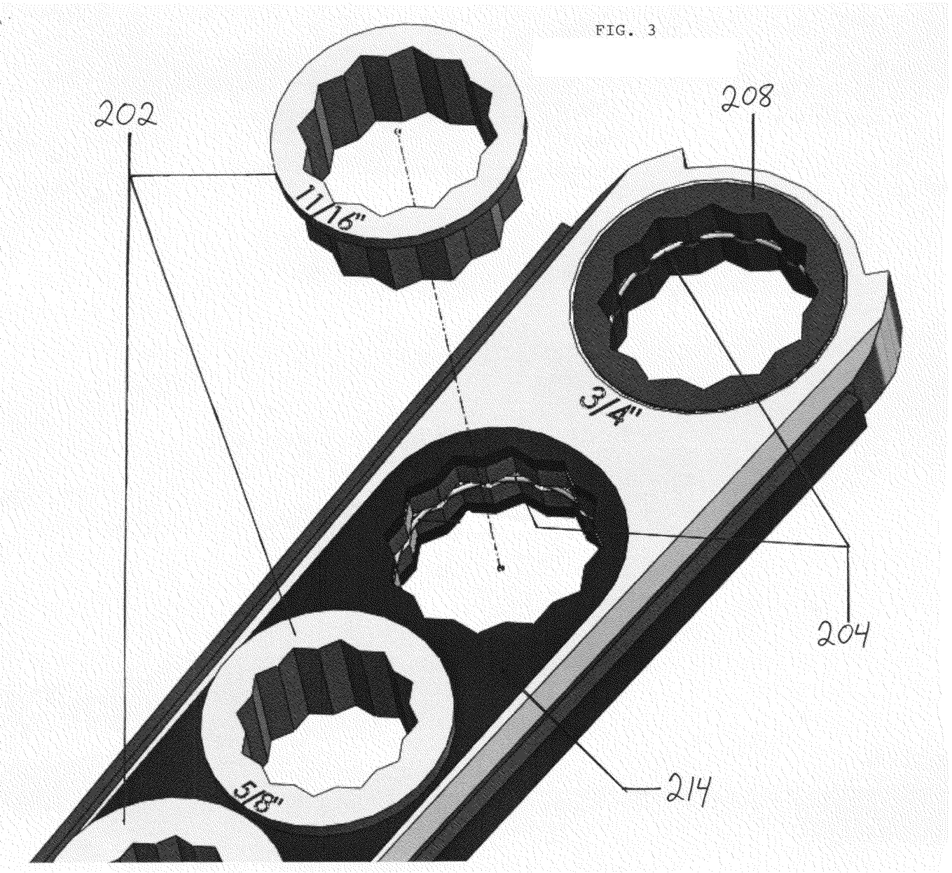

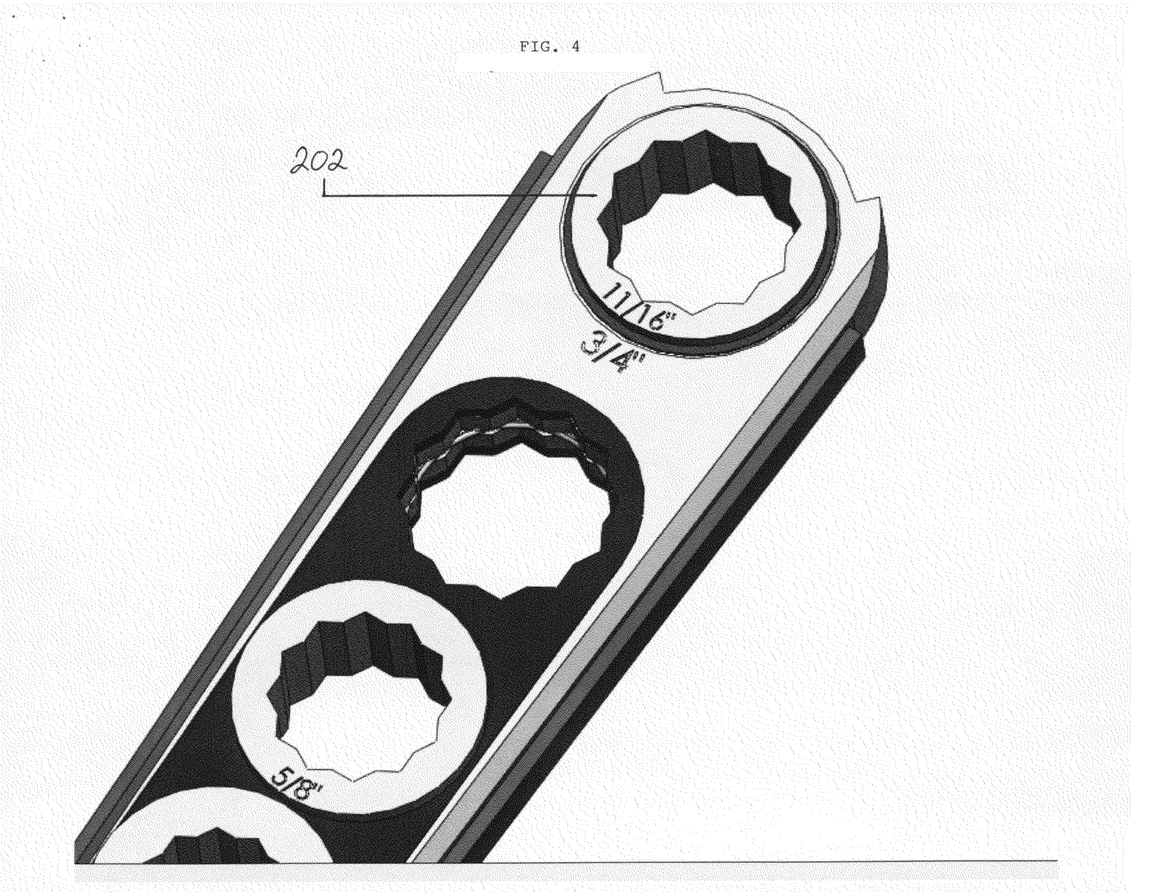

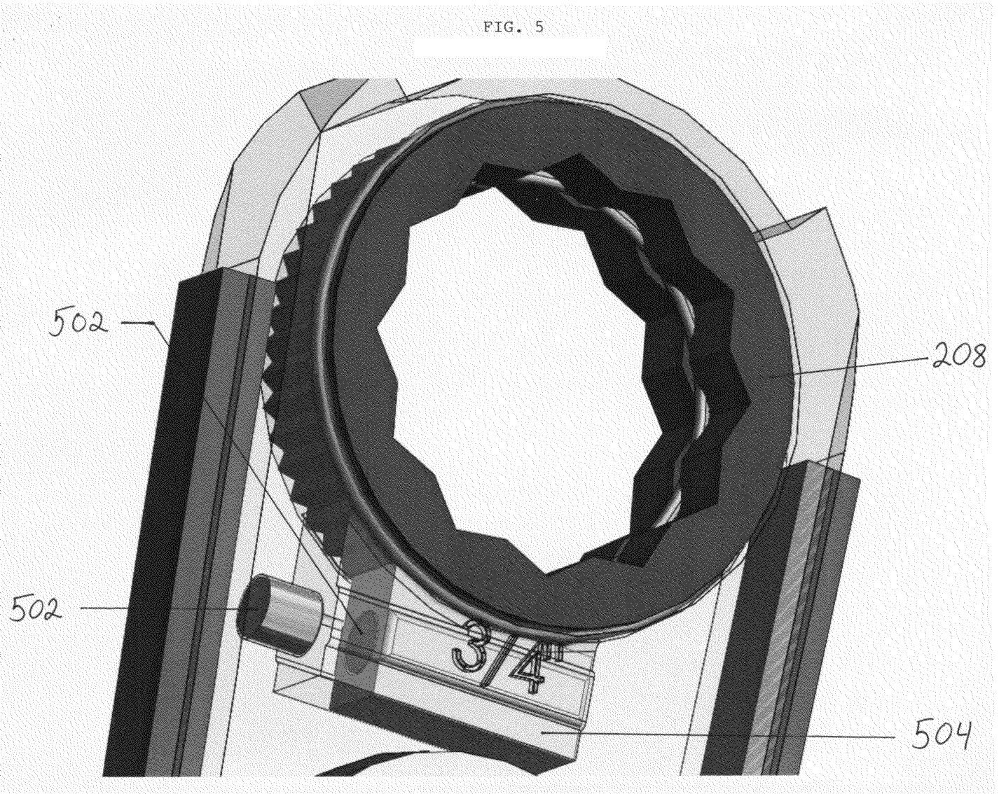

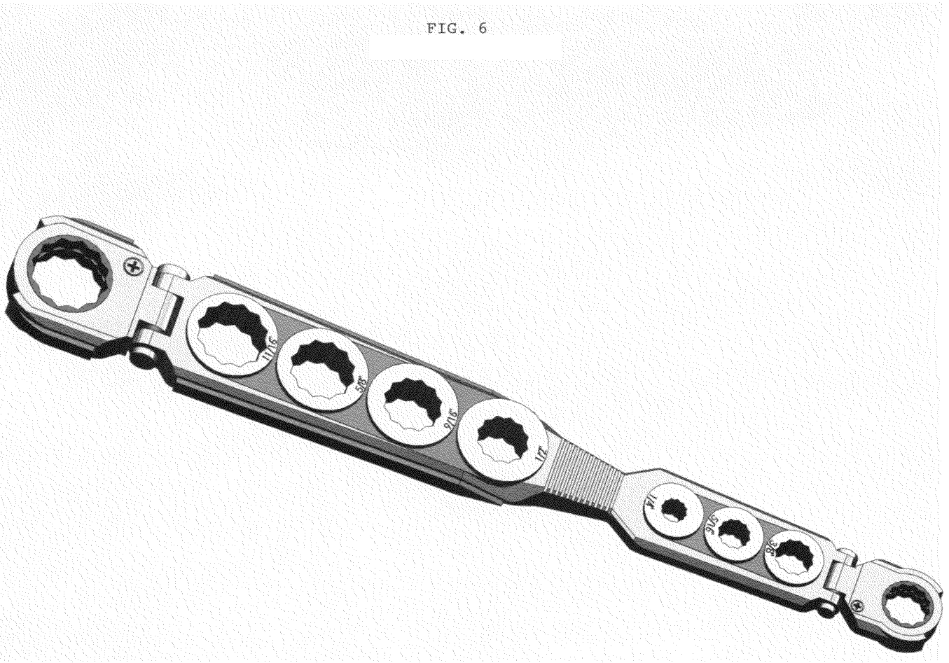

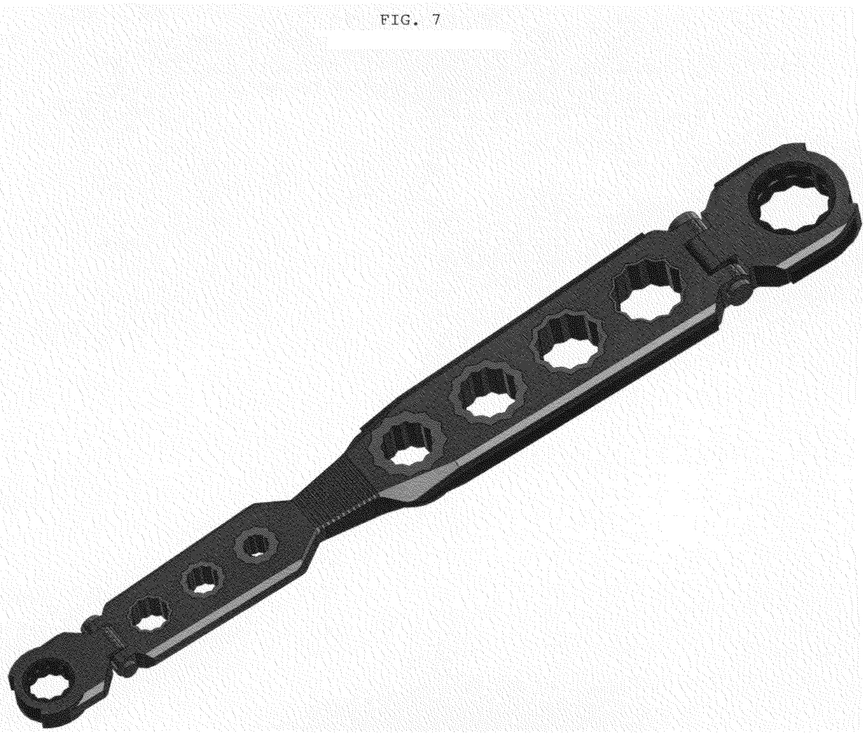

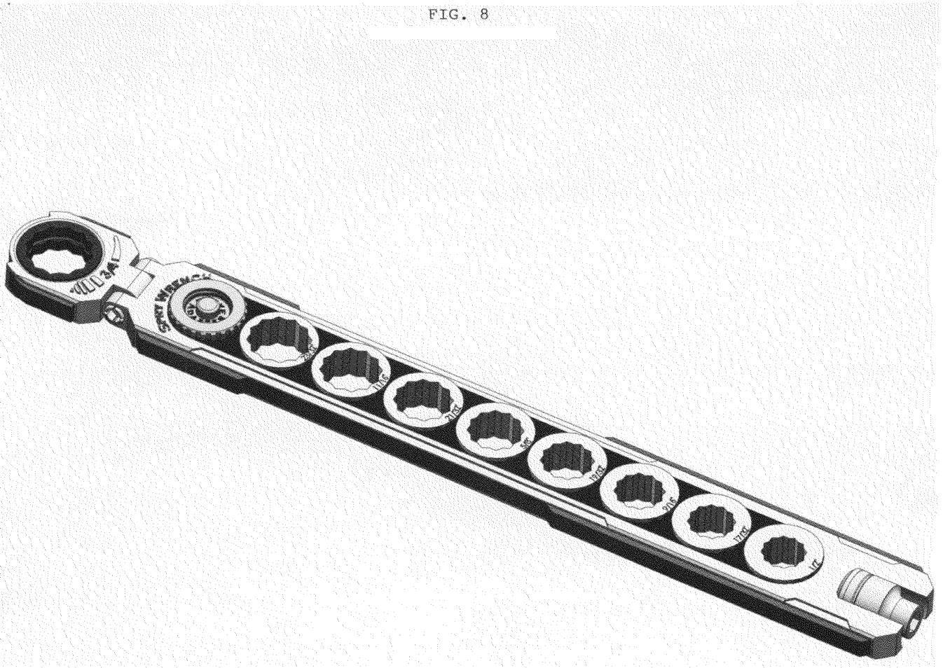

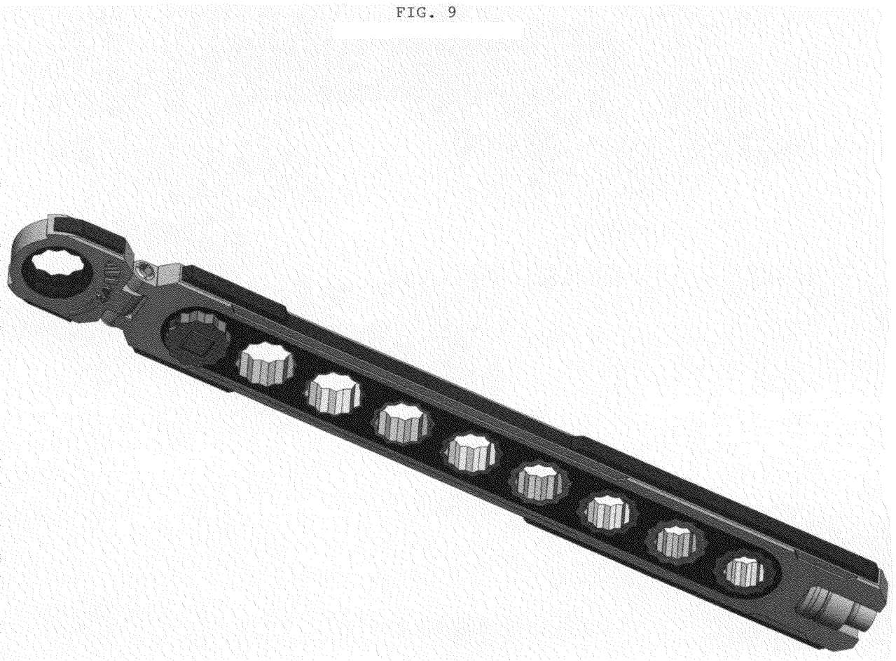

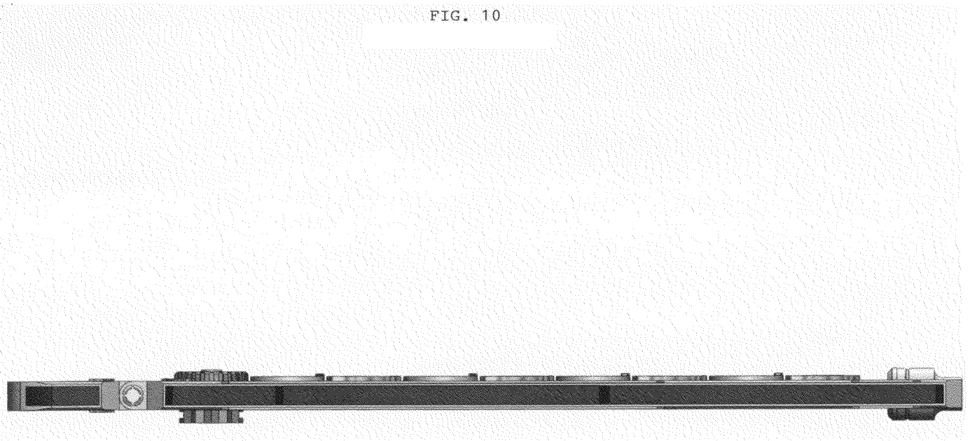

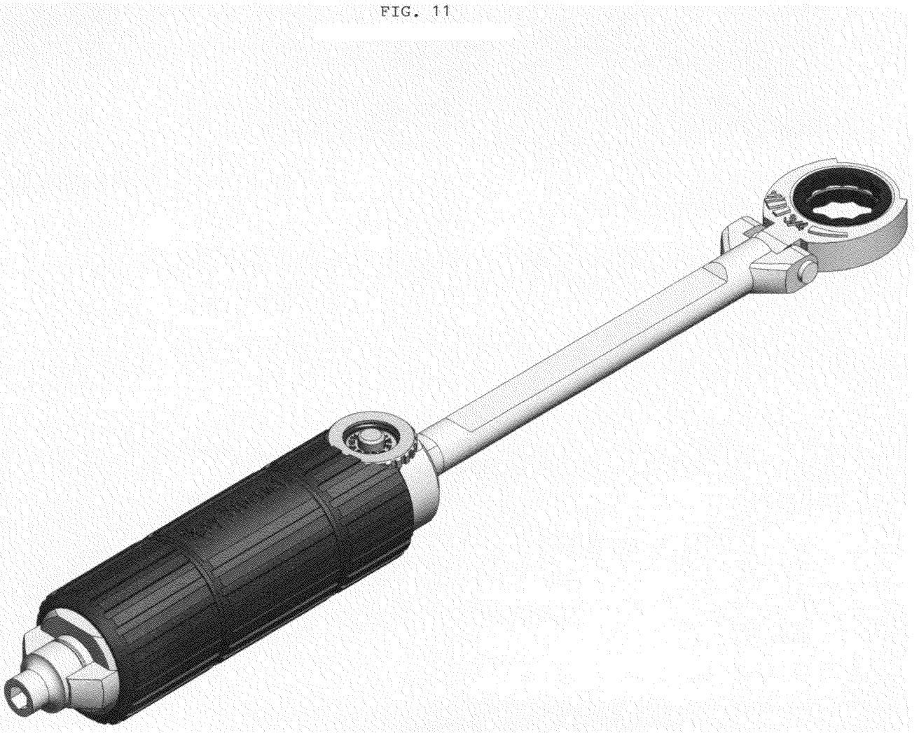

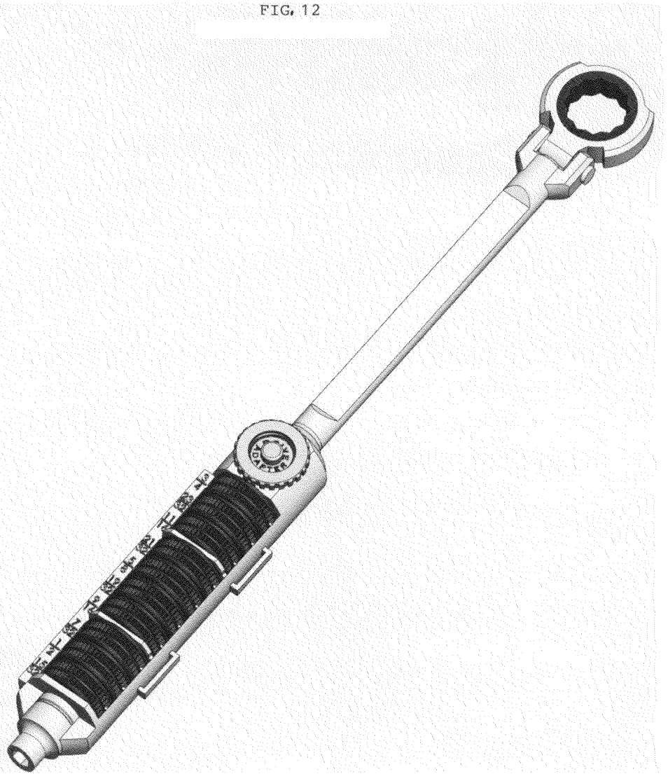

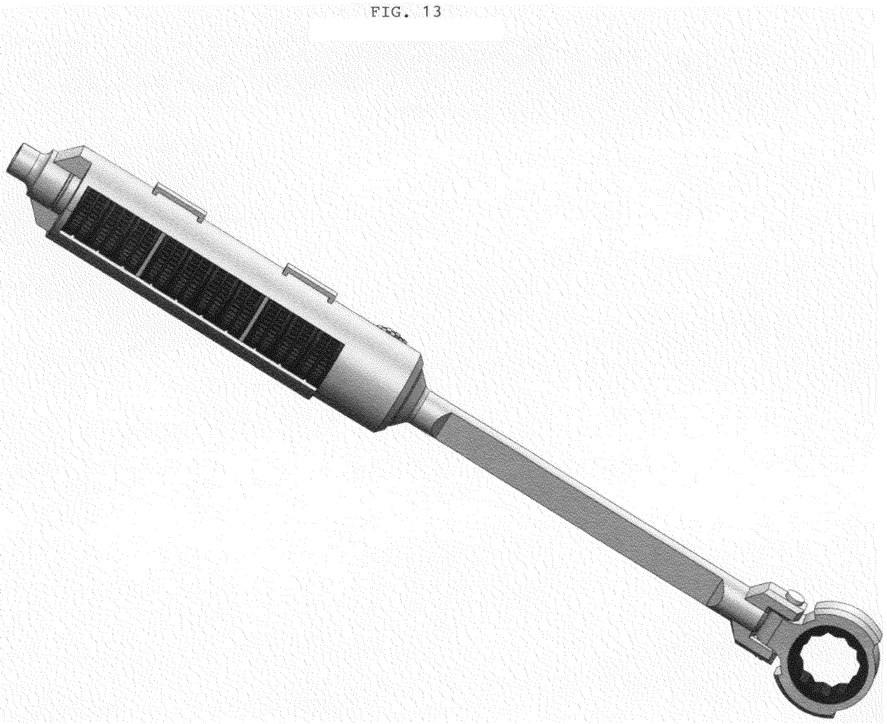

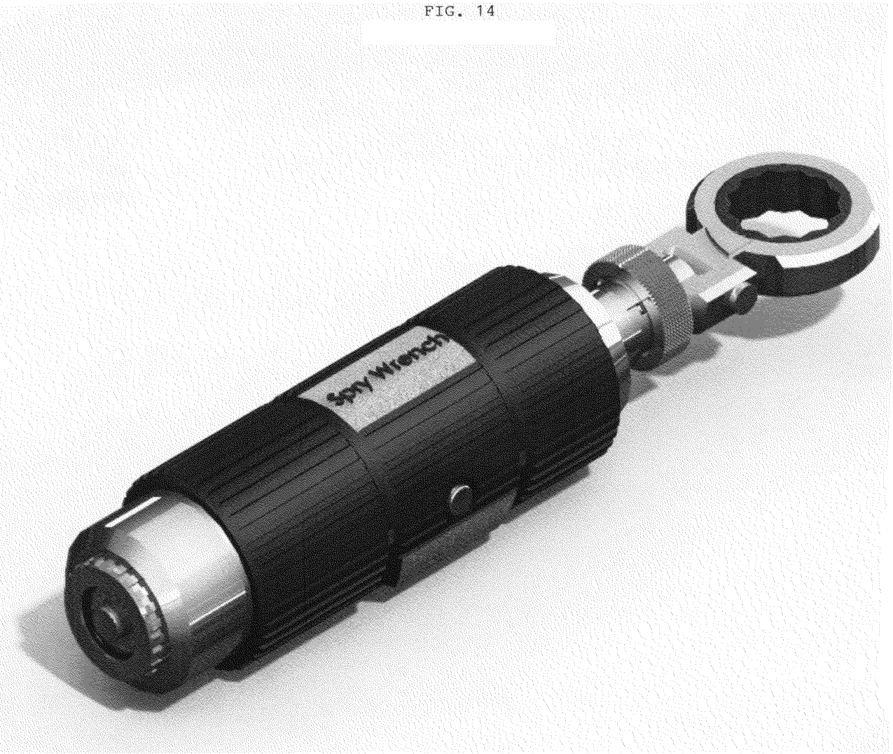

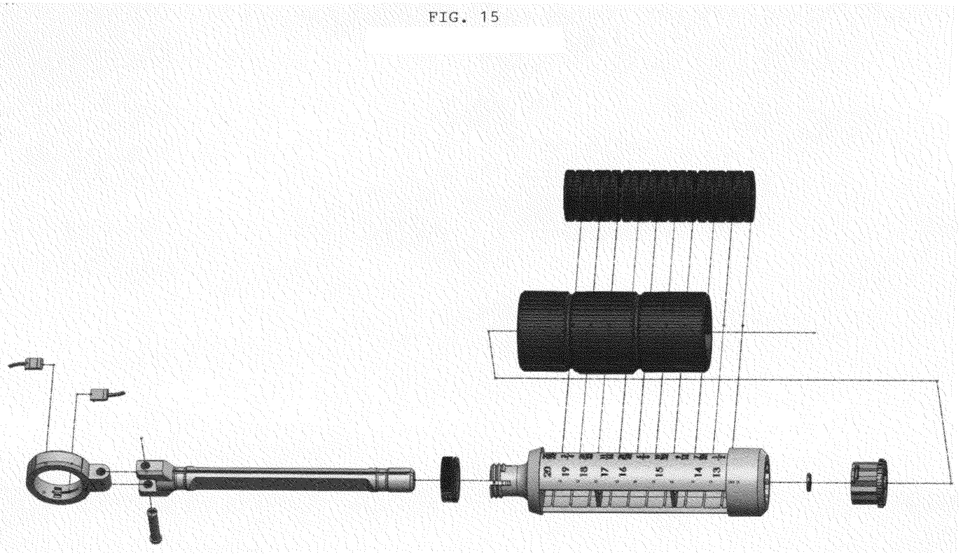

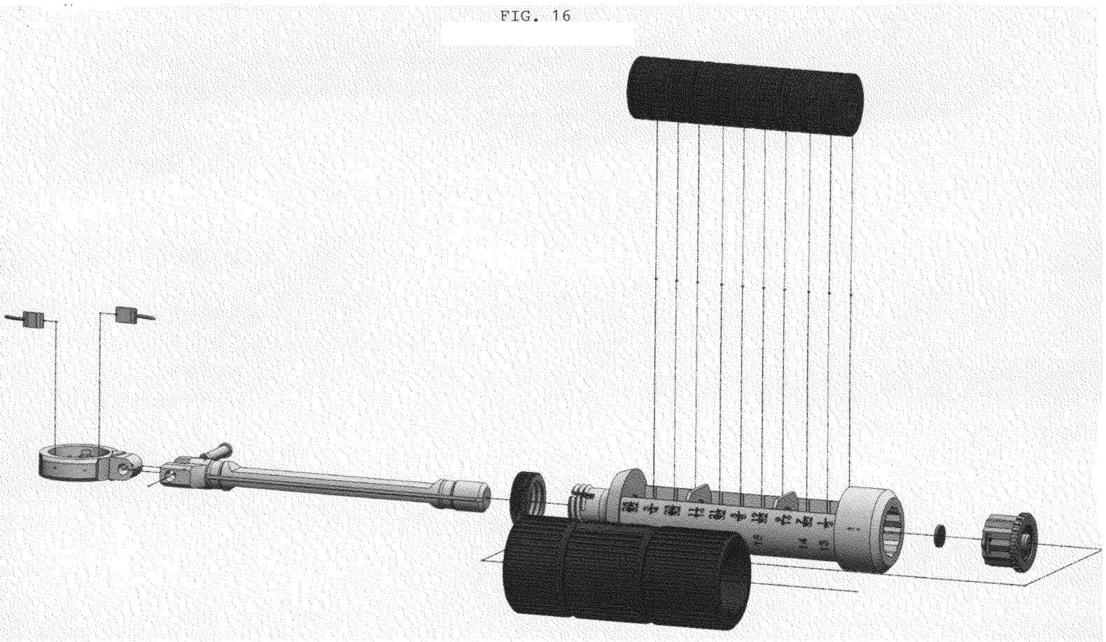

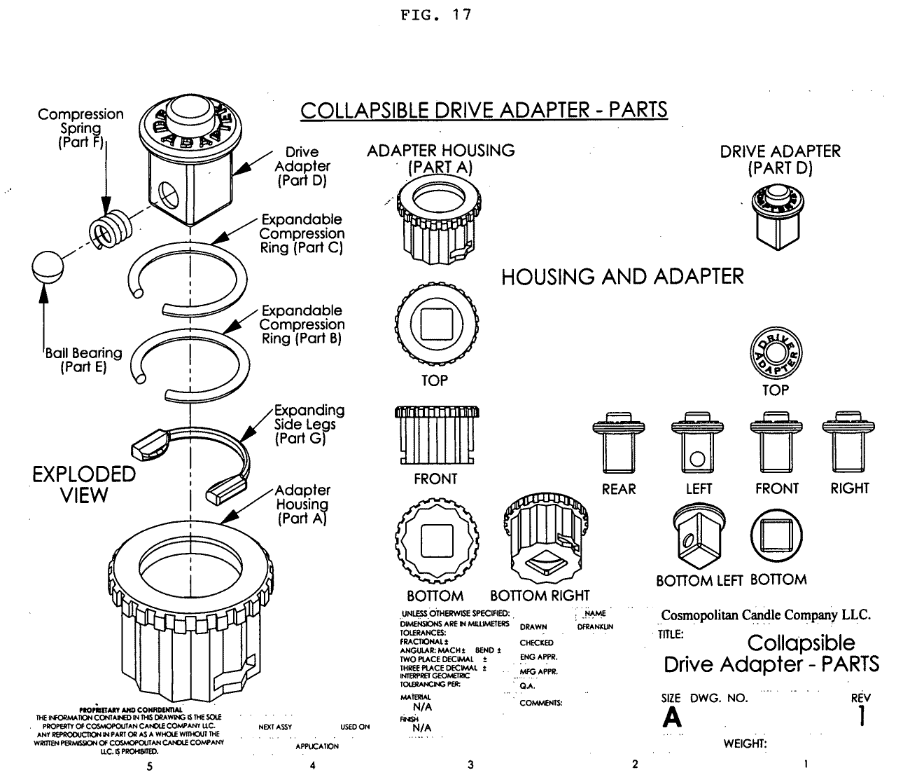

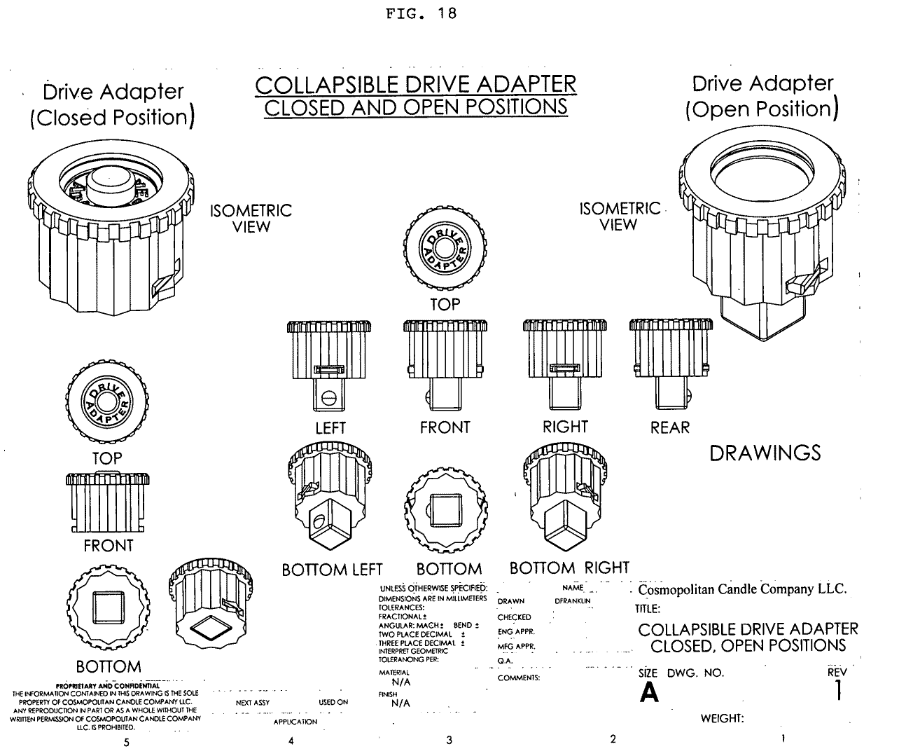

FIG. 1 is a frontal view of the magnetic double-sided ratchet wrench with built-in removable inserts 100. FIG. 2 shows the different components of the magnetic double sided ratchet wrench with built-in removable inserts. For example, FIG. 2 shows removable inserts 202, rubber side grips 204, an adjustable pawl ring 206, a ratchet 208, opposing magnetic cylinders 210, cast iron wrench body 212, magnetic strips 214, a pawl 216, and an opposing cylinder magnet 218. In one embodiment, the “Spry Sockets” may be held in place by two mechanisms: 1) the lip (not shown) on the top of each spry socket 202; and 2) the expandable retainer ring 206 that prevents the socket 202 from being removed from the ratchet 208 parts. FIG. 3 shows removable inserts 202, an adjustable ring 204 for securing a nut (not shown) or the removable inserts 202. FIG. 3 also shows a magnetic strip 206 as an alternative way to secure the inserts 202 to the wrench 212. FIG. 4 illustrates a removable insert 202 secured in place by the adjustable ring 206. FIG. 5 shows an opposing magnetic cylinder 502 embedded into the pawl 216 and also shows the pawl 216 with the cylinder magnet inside 504.

These “Spry Sockets” can be held in place on the wrench 212 itself by one of two mechanisms: the expandable retainer ring 206 that prevents the socket from being removed from the spry wrench 212 or by the magnetic strips 214 that naturally attract to the metallic spry sockets 202.

In operation, the present invention is a wrench with a thru-ratcheting socket on both ends. These two ratcheting sockets have the following main characteristics:

1) Can be used to loosen and tighten nuts and bolts on by themselves;

2) Can be used with the removable “Spry Sockets” to adjust for the appropriate; size of the particular nut or bolt that needs to be worked with;

3) One-way ratchets, but can be made to be adjustable; and

4) Magnets 214 are used instead of springs to keep the pawl 216 engaged with the ratchet 208.

The unique features of the wrench 212 are the inherent designs of the wrench 212 and the removable inserts 202 that keep the sockets readily available and easy to swap for different sized nuts and the magnetic “spring” that is used in the pawl 216 and ratchet mechanism 208.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A ratchet wrench comprising:
a wrench body comprising at least one opening each of at least one said opening adapted to receive an insert,
said wrench body further comprising at least one seat for removably storing at least one insert therein;
wherein each of at least one said insert is configured to fit into and engage a ratcheting mechanism in said wrench at one of at least said one opening;
wherein said ratchet wrench can be used to fasten or remove hardware when one of said at least one inserts is secured in one of said at least one said opening and placed on said hardware.

2. A ratchet wrench according to claim 1, wherein said at least one insert is one of from the group consisting of sockets, drivers, bits and adapters.

3. A ratchet wrench according to claim 1, wherein said at least one insert is configured to adapt to one from the group consisting of nuts, bolts, screws and adaptable tool fittings.

4. A ratchet wrench according to claim 1, wherein said wrench comprises two openings.

5. A ratchet wrench according to claim 1, wherein said wrench comprises at least seven seats.

6. A ratchet wrench according to claim 1, wherein said wrench comprises at least seven inserts.

7. A ratchet wrench according to claim 6, wherein said wrench comprises at least sixteen inserts.
